(19) United States
(12) Patent Application Publication
(10) Pub. No.: US 2024/0093011 A1
(43) Pub. Date: Mar. 21, 2024

(54) LIGHT-WEIGHT COMPOSITE COMPOSITION AND METHOD FOR PREPARING LIGHT-WEIGHT COMPOSITE

(71) Applicant: LG ELECTRONICS INC., Seoul (KR)

(72) Inventor: Taegyu JIN, Seoul (KR)

(21) Appl. No.: 18/274,351

(22) PCT Filed: Jan. 21, 2022
(86) PCT No.: PCT/KR2022/001121

§ 371 Date: Jul. 26, 2023

(30) Foreign Application Priority Data
Jan. 29, 2021 (KR) 10-2021-0012864

(51) Int. Cl. C08L 23/12; B29C 48/00; C08J 5/04; C08K 5/14; C08K 7/14; C08K 7/28; C08L 51/06

(52) U.S. Cl. CPC C08L 23/12; B29C 48/022; C08J 5/043; C08K 5/14; C08K 7/14; C08K 7/28; C08L 51/06; B29K 2023/12; C08K 2201/016; C08L 2203/20; C08L 2203/30; C08L 2205/02

(57) ABSTRACT

The present invention relates to a light-weight composite composition and a method for preparing a light-weight composite. The light-weight composite composition according to the present invention has a significant reduction in weight and an enhancement in mechanical properties compared with a raw material by comprising 50-80 wt % of a polyolefin resin, 10-30 wt % of an inorganic additive, 5-10 wt % of a reinforcing member, and 3-10 wt % of a compatibilizer.

### TECHNICAL FIELD

The present invention relates to a composite composition for preparing a lightweight composite that is lighter than the related art and has improved mechanical properties, and a method of preparing the lightweight composite.

### BACKGROUND ART

Since plastics (synthetic resins) have low specific gravity and excellent strength, and are easy to mold and can be molded into any shape, plastics are also widely used for small electronic devices such as mobile terminals (cell phones, etc.), portable game terminals, and portable players. PCs (body and monitor), televisions, various recording devices, radios, AV devices such as office electronic devices such as printers, copiers, and facsimiles, covers (cases, housings, etc.) of various electronic devices such as OA devices and vacuum cleaners.

There are many types of plastics, and various plastics excellent in weather resistance, impact resistance, transparency, surface elevation, elasticity, toughness, and the like are used depending on the application.

Recently, there is a tendency to use plastics to replace metals, and for this purpose, not only a light weight, but also high strength is required for stability.

To manufacture these plastics, glass fiber mat reinforced thermoplastics (GMT), which is a plate-shaped composite material in which a polymer resin is reinforced with a glass fiber mat as a reinforcing material, low weight reinforced thermoplastics (LWRT) made by mixing a polymer resin and glass fiber, and the like have been developed.

Korean Laid-Open Patent Publication No. 10-2017-0123319 (published date:) discloses a polyamide composition including hollow glass microspheres and an article and a preparation method related thereto, but polyamide resins have disadvantages in that chemical resistance and recyclability are inferior to those of polyolefin-based resins, particularly propylene-based resins.

### DISCLOSURE

### Technical Problem

Accordingly, the present invention is directed to providing a lightweight composite composition having improved mechanical properties while using a polyolefin-based resin having excellent formability and corrosion resistance, a low specific gravity and low cost as a base resin.

The present invention is also directed to providing a method of preparing a lightweight composite exhibiting a light weight and high strength while minimizing a breakage rate of inorganic additives.

The objects of the present invention are not limited to the above-mentioned objects, and other objects and advantages of the present invention not mentioned above can be understood by the following description and will be more clearly understood by the examples of the present invention. It will also be readily apparent that the objects and advantages of the present invention may be realized by the means and combinations thereof set forth in the claims.

### Technical Solution

In order to solve the above-described technical problem, the present invention provides a lightweight composite composition characterized by including a polyolefin-based resin capable of minimizing the pressure of an inorganic additive added for weight reduction by maintaining a melt index as high as possible, an inorganic additive for weight reduction, a reinforcing material for improving mechanical properties, and a compatibilizer for combining the base resin, inorganic additive, and reinforcing material.

Specifically, the lightweight composite composition according to the present invention includes 50 to 80% by weight of a polyolefin-based resin, 10 to 30% by weight of an inorganic additive having a specific gravity of 0.1 to 0.6 g/cm³, 5 to 10% by weight of a reinforcing material having an aspect ratio of 200 to 1000, and 3 to 10% by weight of a compatibilizer.

At this time, when the inorganic additive and the reinforcing material are included in the lightweight composite composition at the same time, increasing the content of the inorganic additive may increase the weight reduction effect but decrease the mechanical properties, and increasing the content of the reinforcing material may improve the mechanical properties but reduce the weight reduction effect.

Therefore, in the lightweight composite composition according to the present invention, the inorganic additive is designed to be included in an amount of 10 to 30% by weight of the total weight of the lightweight composite and the reinforcing material is designed to be included in an amount of 5 to 10% by weight, thereby optimizing the weight reduction effect and mechanical property improvement effect.

In addition, the lightweight composite composition may have a melt index of 14 to 20 g/10 min as measured by ASTM D1238.

The polyolefin-based resin may be one or more selected from the group consisting of polypropylene (PP), polyethylene (PE), and polybutylene (PB), the additive may be selected from the group consisting of hollow glass, calcium carbonate, titanium oxide, and silica, and the reinforcing material may be glass fiber or carbon fiber.

In addition, the compatibilizer may be one or more selected from the group consisting of 2,5-dimethyl-2,5-bis(t-butylperoxy)hexane, 1,3-bis(t-butylperoxyisopropyl)benzene, methyl ethyl ketone peroxide, 2,5-dimethyl-2,5-di(benzoyloxy)hexane, di-t-butylperoxide, 2,5-dimethyl-2,5-(t-butylperoxy)-3-hexane, n-butyl-4,4-bis(t-butylperoxy)valerate, a,a′-bis(t-butylperoxy)diisopropylbenzene, and maleic anhydride.

In addition, the present invention provides a method of preparing a lightweight composite composition capable of maintaining a light weight and high strength by minimizing the breakage of the inorganic additive.

Specifically, the method of preparing a lightweight composite composition according to the present invention includes: supplying polypropylene and a compatibilizer to a main feeder; supplying hollow glass to a first side feeder provided downstream of the main feeder to mix the hollow glass with a mixture of the polypropylene and the compatibilizer; supplying glass fiber to a second side feeder provided downstream of the first side feeder to mix the glass fiber with the mixture; and extruding the mixture through an extrusion die.

At this time, the extrusion of the mixture is preferably performed at a loading of less than 50%.

### Advantageous Effects

The lightweight composite composition according to the present invention can be applied to various products by using a polyolefin-based resin having excellent formability, corrosion resistance, a low specific gravity, and low cost as a base resin, and can be applied as a component material of a finished product requiring a light weight to reduce power consumption due to weight reduction during operation.

In addition, the lightweight composite composition according to the present invention can reduce the load applied to muscles even in a product that needs to be carried and moved by a person.

In addition, the method of preparing a lightweight composite according to the present invention can maximize the melt index, can minimize a breakage rate of the inorganic additive by performing extrusion at a loading of less than 50%, and can reliably realize a reduction in weight and mechanical property enhancement of the composite.

In addition to the above-described effects, the specific effects of the present invention will be described together while describing specific details for carrying out the invention below.

### BRIEF DESCRIPTION OF DRAWINGS

FIG. 1 is a flow chart showing a method of preparing a lightweight composite according to the present invention.

FIG. 2 is a graph showing the specific gravity and tensile strength when glass fiber is used as a reinforcing material and when microcellulose is used as a reinforcing material, in the lightweight composite composition according to the present invention.

### [Best Mode for Implementation of the Invention]

The above objects, features, and advantages will be described in detail below, and accordingly, those skilled in the art will be able to easily implement the technical spirit of the present invention. In the description of the present invention, when it is determined that a specific description of a known function or configuration may unnecessarily obscure the gist of the present invention, the detailed description thereof will be omitted. Hereinafter, preferred embodiments of the present disclosure will be described in more detail.

The present invention is not limited to the embodiments disclosed below, and may be embodied in various different forms, and the embodiments are provided merely for the complete disclosure of the invention, and for the purpose of fully informing one skilled in the art to which the invention pertains.

Hereinafter, the arrangement of an arbitrary component on the “upper portion (or lower portion)” of a component or “above (or below)” the component means that the arbitrary component is not only disposed in contact with the upper surface (or lower surface) of the component, but also other components may be interposed between the component and any component may be disposed on (or under) the component.

In addition, when a component is described as being “connected,” “coupled,” or “connected” to another component, it is to be understood that the components may be directly coupled or connected to one another, but that other components may be “interposed” between the components, or that each component may be “connected,” “coupled,” or “coupled” through another component.

In this specification, the singular expression includes the plural expression unless the context clearly dictates otherwise. In this application, terms such as “consisting of” or “comprising” should not be construed as necessarily including all of the various components or steps described in the specification, and it should be construed that some of the components or steps may not be included, or additional components or steps may be further included.

In addition, in this specification, the singular expression includes the plural expression unless the context clearly dictates otherwise. In this application, the terms such as “consist of” or “include” should not be construed as necessarily including all of the various elements or steps described in the specification, and it should be construed that some components or steps among them may not be included, or additional components or steps may be further included.

Throughout the specification, when “A and/or B” is used, this means A, B, or A and B unless otherwise specified, and when “C to D” is used, this means C or more and D or less, unless otherwise specified.

Hereinafter, the lightweight composite composition according to the present invention and the method of preparing a lightweight composite will be described in detail.

The present invention provides a lightweight composite composition including: 50 to 80% by weight of a polyolefin-based resin: 10 to 30% by weight of an inorganic additive having a specific gravity of 0.1 to 0.6 g/cm³; 5 to 10% by weight of a reinforcing material having an aspect ratio of 200 to 1000; and 3 to 10% by weight of a compatibilizer.

The lightweight composite composition according to the present invention can be applied to various products by using a polyolefin-based resin, which is a general-purpose material, as a base resin, and can be applied as a component material of a finished product requiring a light weight to reduce power consumption due to weight reduction during operation.

In addition, the lightweight composite composition according to the present invention can reduce the load applied to muscles even in a product that needs to be carried and moved by a person.

In the lightweight composite composition according to the present invention, the polyolefin-based resin has excellent chemical stability and corrosion resistance, and is useful for reducing the weight of the material. The polyolefin-based resin may be one or more selected from the group consisting of polypropylene, polyethylene, and polybutylene having a weight average molecular weight of 100,000 to 150,000, and may be a polypropylene homopolymer or a polypropylene copolymer.

The polypropylene homopolymer is preferably an isotactic polymer containing 99% by weight or more of a propylene monomer, and this is because the isotactic polymer has high crystallinity, a high melting point, and high mechanical strength.

The polypropylene copolymer is a copolymer of a propylene monomer and an ethylene monomer, and a content of the ethylene monomer is 0.5 to 10% by weight, preferably 1 to 5% by weight, and through this, impact resistance may be greatly increased while maintaining high mechanical strength.

The polyolefin-based resin may be included in an amount of 50 to 80% by weight of the total weight of the lightweight composite composition. When the polypropylene-based resin is included in an amount less than 50% by weight, there is a problem in that the extrudability of the composite and the mechanical strength of the composite are lowered, and when the resin is included in an amount exceeding 80% by weight, there is a problem in that a lightweight composite having a greatly reduced weight cannot be manufactured.

In addition, the inorganic additive may be included to reduce the weight of the lightweight composite composition according to the present invention, and an excellent weight reduction effect may be obtained because it has a low specific gravity.

In the lightweight composite composition according to the present invention, the inorganic additive may be selected from the group consisting of hollow glass, calcium carbonate, titanium oxide, and silica.

The inorganic additive may have an average diameter of 10 to 1,000 μm and a specific gravity of 0.1 to 0.6 g/cm³. The inorganic additive may affect a filling rate, a reduction in shrinkage rate, an anti-torsion effect, and the like due to differences in average diameter and specific gravity.

The inorganic additive may be included in an amount of 10 to 30% by weight of the total weight of the lightweight composite composition. When the hollow glass is included in an amount less than 10% by weight, there is a problem that the weight is not reduced compared to the raw material, and when the hollow glass is included in an amount exceeding 30% by weight, there is a problem that mechanical properties such as tensile strength, flexural strength, flexural modulus, and impact strength deteriorate.

Here, the reduction in weight compared to the raw material can be expressed as a ratio of weight to the same volume, that is, density, and represents a decrease in weight in the same volume. That is, the total weight of the composite made of the lightweight composite composition according to the present invention is reduced in the same volume as that of the material made of only the polyolefin-based resin.

In addition, the reinforcing material may be added to improve the rigidity and molding processability of the lightweight composite composition according to the present invention, and the reinforcing material may be glass fiber or carbon fiber.

When the glass fiber is used, the glass fiber may have a diameter of 10 to 24 μm and an elastic modulus of 70 GPa or more. In addition, when carbon fiber is used, the carbon fiber may be pitch-based carbon fiber, be prepared using polyacrylonitrile or silicon carbide as a precursor, have a diameter of 5 to 20 μm, and have an elastic modulus of 230 GPa or more.

The reinforcing material may be included in an amount of 5 to 10% by weight of the total weight of the lightweight composite composition. When the reinforcing material is included in an amount less than 5% by weight, the mechanical strength of the lightweight composite is not improved, and when the reinforcing material is included in an amount exceeding 10% by weight, a content of the inorganic additive relative to the reinforcing material is lowered, thereby making it impossible to prepare a lightweight composite.

In particular, when the inorganic filler and the reinforcing material are included in the lightweight composite composition at the same time, increasing the content of the inorganic filler may increase the weight reduction effect but decrease the mechanical properties, and increasing the content of the reinforcing material may improve the mechanical properties but reduce the weight reduction effect.

Therefore, in the lightweight composite composition according to the present invention, the inorganic additive is designed to be included in an amount of 10 to 30% by weight of the total weight of the lightweight composite and the reinforcing material is designed to be included in an amount of 5 to 10% by weight, thereby optimizing a weight reduction effect and a mechanical property improvement effect.

In addition, in the lightweight composite composition according to the present invention, the base resin is an organic material, and the inorganic additive and reinforcing material added for weight reduction and reinforcement are inorganic materials, so that physical bonding is achieved only by mixing different materials.

Therefore, in the lightweight composite composition according to the present invention, the compatibilizer is included to secure bonding strength between the polyolefin resin, the inorganic additive, and the reinforcing material, and the compatibilizer may be included in an amount of 3 to 10% by weight of the total weight of the lightweight composite composition.

The compatibilizer may be one or more selected from the group consisting of 2,5-dimethyl-2,5-bis(t-butylperoxy)hexane, 1,3-bis(t-butylperoxyisopropyl)benzene, methyl ethyl ketone peroxide, 2,5-dimethyl-2,5-di(benzoyloxy)hexane, di-t-butylperoxide, 2,5-dimethyl-2,5-(t-butylperoxy)-3-hexane, n-butyl-4,4-bis(t-butylperoxy)valerate, a,a′-bis(t-butylperoxy)diisopropylbenzene, and maleic anhydride.

In addition, the lightweight composite composition according to the present invention may further include a dispersing agent for uniform mixing, and stearic acid or the like may be used as the dispersing agent, and the dispersing agent may be input in an amount of 0.5% by weight or less of the total weight of the lightweight composite composition.

In addition, the lightweight composite composition according to the present invention may further include an antioxidant to prevent oxidation, and the antioxidant may be phenol-based, phosphorus-based, sulfur-based, or amine-based. In this case, the antioxidant may be input in an amount of 0.1% by weight or less.

The lightweight composite composition according to the present invention may have a melt index of 14 to 20 g/10 min as measured by ASTM D1238. When the melt index is less than 14 g/10 min, the flowability of the lightweight composite composition is lowered, and thus the inorganic additive is damaged, and when the melt index exceeds 20 g/min, there is a problem that the molten composite comes out of a mold gap, and thus burrs are generated.

In addition, the present invention provides a method of preparing a lightweight composite, including: supplying polypropylene and a compatibilizer to a main feeder; supplying hollow glass to a first side feeder provided downstream of the main feeder to mix the hollow glass with a mixture of the polypropylene and the compatibilizer; supplying glass fiber to a second side feeder provided downstream of the first side feeder to mix the glass fiber with the mixture; and extruding the mixture through an extrusion die.

The method of preparing a lightweight composite according to the present invention can maximize the melt index, can minimize a breakage rate of the inorganic additive by performing extrusion at a loading of less than 50%, and can reliably realize a reduction in weight and mechanical property enhancement of the composite.

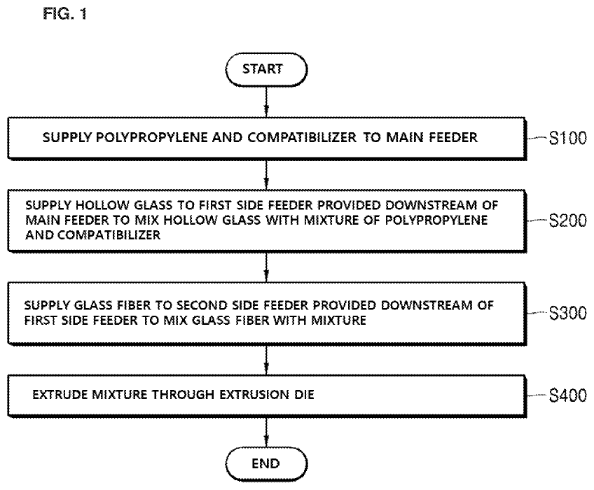

FIG. 1 is a flow chart showing a method of preparing a lightweight composite according to the present invention. Hereinafter, the present invention will be described in detail with reference to FIG. 1.

The method of preparing a lightweight composite according to the present invention includes supplying polypropylene and a compatibilizer to a main feeder (S100).

The lightweight composite according to the present invention has low bonding strength because it includes organic and inorganic materials and is bonded only by physical bonding strength, but the composite may maximize the bonding strength between polypropylene as a base resin, the inorganic filler, and the reinforcing material by including a compatibilizer.

In addition, when the polypropylene and the compatibilizer are supplied to the main feeder, a dispersant and an antioxidant may be additionally supplied, and a kneading area may be further included downstream of the main feeder to more uniformly mix the polypropylene and the compatibilizer.

Next, the method of preparing a lightweight composite according to the present invention includes supplying hollow glass to a first side feeder provided downstream of the main feeder to mix the hollow glass with a mixture of the polypropylene and the compatibilizer (S200).

In an extrusion process of the method of preparing a lightweight composite according to the present invention, two side feeders are used to smoothly mix hollow glass, which is a low specific gravity additive, and a reinforcing material having a high aspect ratio with polypropylene, which is a base resin.

At this time, hollow glass is supplied to the first side feeder, and a mixture of the polypropylene and the compatibilizer is mixed with the hollow glass.

The method of preparing a lightweight composite according to the present invention includes supplying glass fiber to a second side feeder provided downstream of the first side feeder to mix the glass fiber with the mixture (S300).

The glass fiber may be supplied to the second side feeder provided immediately before a starting point of the extrusion process, thereby minimizing the breakage rate of the hollow glass, which is a brittle material.

In the method of preparing a lightweight composite according to the present invention, the polypropylene is included in an amount of 50 to 80% by weight of the total weight of the lightweight composite, and the hollow glass is included in an amount of 10 to 30% by weight, and the glass fiber is included in an amount of 5 to 10% by weight, thereby reducing a weight and improving mechanical properties.

In addition, the method of preparing a lightweight composite according to the present invention includes extruding the mixture through an extrusion die (S400).

At this time, the extrusion may minimize breakage of the hollow glass by making the loading of the mixture less than 50%. When the loading of the extrusion is 50% or more, there is a problem in that the hollow glass is broken, and thus the lightweight effect of the composite prepared is lost.

Hereinafter, the present invention will be described in detail through Examples. These Examples are only presented as examples in order to explain the present invention in more detail. Therefore, the present invention is not limited to these Examples.

### EXAMPLES

### Example 1: Preparation of Lightweight Composite 1

65% by weight of polypropylene (PolyMirae, product name: HA5029) and 5% by weight of maleic anhydride-grafted polypropylene (COATS) were supplied to a main feeder of a screw-type extruder, and because a breakage rate increases when brittle hollow glass is input into an initial input portion, 20% by weight of hollow glass (3M company, product name: im-16k) was supplied to a first side feeder provided downstream of the main feeder, and the hollow glass was mixed with a mixture of the polypropylene and compatibilizer.

10% by weight of glass fiber (Owens Corning, product name: 995-10p) was supplied to a second side feeder provided downstream of the first side feeder, then the polypropylene, the maleic anhydride-grafted polypropylene, the hollow glass, and the glass fiber were extruded through an extrusion die to prepare a lightweight composite.

At this time, the extrusion of the mixture was performed at a loading of less than 50%.

### Example 2: Preparation of Lightweight Composite 2

A lightweight composite was prepared in the same manner as in Example 1, except that 67% by weight of polypropylene, 5% by weight of maleic anhydride-grafted polypropylene, 20% by weight of hollow glass, and 8% by weight of glass fiber were supplied and extruded.

### Example 3: Preparation of Lightweight Composite 3

A lightweight composite was prepared in the same manner as in Example 1, except that 62% by weight of polypropylene, 10% by weight of maleic anhydride-grafted polypropylene, 20% by weight of hollow glass, and 8% by weight of glass fiber were supplied and extruded.

### Example 4: Preparation of Lightweight Composite 4

A lightweight composite was prepared in the same manner as in Example 1, except that 63% by weight of polypropylene, 10% by weight of maleic anhydride-grafted polypropylene, 19% by weight of hollow glass, and 8% by weight of glass fiber were supplied and extruded.

### Example 5: Preparation of Lightweight Composite 5

A lightweight composite was prepared in the same manner as in Example 1, except that 61% by weight of polypropylene, 10% by weight of maleic anhydride-grafted polypropylene, 20% by weight of hollow glass, and 9% by weight of glass fiber were supplied and extruded.

### Comparative Example 1

A molded article was prepared by injection molding using polypropylene (Lotte Chemical Co., product name: JM-350).

### Comparative Example 2

A molded article was prepared by adding 5% by weight of talc to polypropylene. The above composition is a polypropylene material used as a conventional vacuum cleaner part.

### Comparative Example 3

A molded article was prepared by injection molding using polypropylene (PolyMirae, product name: HA5029).

### Comparative Example 4

80% by weight of polypropylene (PolyMirae, product name: HA5029) and 20% by weight of hollow glass (3M, product name: im-16k) were mixed and injection-molded.

### Comparative Example 5

75% by weight of polypropylene (PolyMirae, product name: HA5029), 5% by weight of maleic anhydride-grafted polypropylene (COATS), and 20% by weight of glass fibers were mixed and injection-molded.

Table 1 below shows the components and contents of each of Examples 1 to 5 and Comparative Examples 1 to 5.

TABLE 1

| | | | Inorganic | | |
|---|---|---|---|---|---|
| | Resin | | additive | Reinforcing | Total |
| | (% by | Compatibilizer | (% by | material (% | (% by |
| Examples | weight) | (% by weight) | weight) | by weight) | weight) |
| Example 1 | 65 | 5 | 20 | 10 | 100 |
| Example 2 | 67 | 5 | 20 | 8 | 100 |
| Example 3 | 62 | 10 | 20 | 8 | 100 |
| Example 4 | 63 | 10 | 19 | 8 | 100 |
| Example 5 | 61 | 10 | 20 | 9 | 100 |
| Comparative | 100 | — | — | — | 100 |
| Example 1 | | | | | |
| Comparative | 95 | — | 5 | — | 100 |
| Example 2 | | | | | |
| Comparative | 100 | — | — | — | 100 |
| Example 3 | | | | | |
| Comparative | 80 | — | 20 | — | 100 |
| Example 4 | | | | | |
| Comparative | 75 | 5 | 20 | — | 100 |
| Example 5 | | | | | |

### Experimental Examples

Experimental Example 1: Analysis of properties of lightweight composite

Impact strength, tensile strength, flexural strength, flexural modulus and density were analyzed to analyze the strength and density of lightweight composites according to Examples of the present invention, and the results are shown in Tables 2 and 3 below.

The lightweight composites prepared in Examples 1 to 5 were extruded in the form of pellets, and measured after performing an injection process according to ASTM standards to measure physical properties. At this time, in order to reduce the error of a measurement value, it was measured using a sample 72 hours after injection.

Melt index (MI): Measured according to ASTM D1238, and specifically, the value was measured by measuring the amount (g) that comes out when the resin is sufficiently melted at 220 to 230° C. and pushed at a constant speed.

IZOD impact strength (kgf·cm/cm): Measured at room temperature (23° C.) under a 1/4 notched condition by ASTM D256.

Tensile strength (MPa): Measured according to ASTM D638.

Specific gravity: Measured according to ASTM D792.

Elongation (%): Measured according to ASTM D638.

Flexural Strength (kgf/cm²): Measured according to ASTM D790.

Flexural modulus (kgf/cm²) Measured according to ASTM D790.

Hardness: Based on ASTM D785, the hardness of the material was measured by the depth into which the tip entered after pressing into a sample surface with an indenter.

Heat deflection temperature (HDT): This is the temperature at which deformation occurs as the temperature rises when a constant load is applied to the plastic, and the temperature was measured according to the standardized test procedure of ASTM D648.

TABLE 2

| | | IZOD impact | Tensile | Specific |
|---|---|---|---|---|
| | Melt Index | strength (kgf · | strength | gravity |
| | (g/10 min) | cm/cm) | (MPa) | (kg/cm³) |
| | Conditions | | | |
| | 10 kg, | 23° C., notched, | 50 | |
| Examples | 220° C. | 3.2 mm | mm/min | — |
| Example 1 | 14.25 | 2.3 | 30.8 | 0.833 |
| Example 2 | 16 | 2.4 | 24.8 | 0.807 |
| Example 3 | 19 | 2.1 | 31.4 | 0.812 |
| Comparative | 10 | 8.5 | 23 | 0.9 |
| Example 1 | | | | |
| Comparative | 12.3 | 5.7 | 28.9 | 1.061 |
| Example 2 | | | | |
| Comparative | 72 | 2.4 | 36.8 | 0.915 |
| Example 3 | | | | |
| Comparative | 25.5 | 1.6 | 15.6 | 0.789 |
| Example 4 | | | | |
| Comparative | 28 | 1.5 | 18.2 | 0.81 |
| Example 5 | | | | |

Referring to Table 2, it can be seen that Examples 1 to 3 including polypropylene (PolyMirae, product name: HA5029), maleic anhydride grafted polypropylene, hollow glass, and glass fiber had generally excellent melt indices, IZOD impact strength, tensile strength and specific gravity compared to samples (Comparative Example 1) extruded with only polypropylene (product name: JM 350 (Lotte Chemical Co.)).

Specifically, the higher the melt index, the better the flowability and the lower the breakage rate, and it can be seen that better flowability was exhibited due to high melting indices compared to Comparative Example 2 with a commercially available composition, and although impact strength may be slightly lowered, the impact strength and tensile strength show strengths suitable for actual product application, and in particular, the composites are lightweight with low specific gravities.

TABLE 3

| Experiment items | Conditions | | Units | Example 4 | Example 5 |
|---|---|---|---|---|---|
| MI | 2.16 kg, 230° C. | | g/10 min | 20 | 17 |
| IZOD impact | 23° C., notched, | | kgf · | 2.4 | 2.3 |
| strength | 3.2 mm | | cm/cm | | |
| Tensile strength | 50 | mm/min | MPa | 30 | 33 |
| Elongation | | | % | 3.7 | 3.8 |
| Flexural strength | 30 | mm/min | kg/cm² | 548 | 585 |
| Flexural modulus | | | | 31308 | 28425 |
| Hardness | R-scale | | — | 102.1 | 96 |
| Specific gravity | — | | kg/cm³ | 0.837 | 0.834 |
| HDT | 4.6 | kg | ° C. | 157.3 | 157.1 |

As shown in Table 3, although an amount of hollow glass and glass fiber was slightly changed in Examples 4 and 5 according to the present invention, it can be seen that the specific gravity and tensile strength are still excellent.

Therefore, it can be seen that a composite having excellent strength and a light weight may be prepared with the content applied in the present invention.

Experimental Example 2: Analysis of specific gravity and tensile strength of composite according to reinforcing material

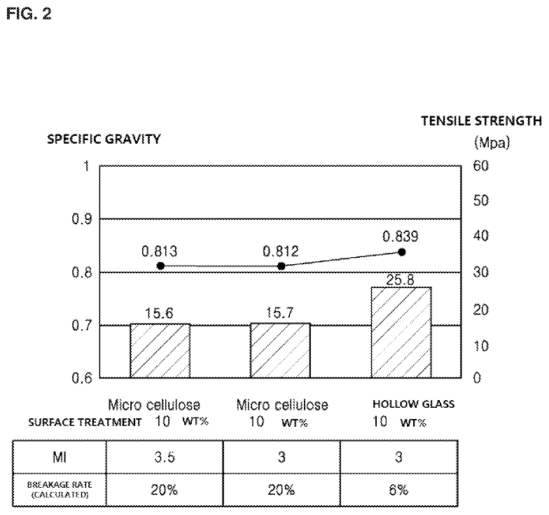

In the lightweight composite composition according to the present invention, specific gravity and tensile strength were analyzed when glass fiber was used as a reinforcing material and when microcellulose was used as a reinforcing material, and the results are shown in FIG. 2.

The materials shown in FIG. 2 have the same types and contents of polypropylene, maleic anhydride polypropylene, and hollow glass materials constituting the composite so that the contrast for the effect of adding glass fibers is clear, and microcellulose, surface-treated microcellulose, and glass fiber were added and analyzed.

As shown in FIG. 2, it can be seen that among the composites including the surface-treated microcellulose, microcellulose, and glass fiber, the composite including the glass fiber exhibited the highest tensile strength.

Therefore, it can be seen that the tensile strength reinforcing effect is high when the glass fiber is used in preparing the composite.

In addition, although the melt index shows a similar value, it can be seen that a breakage rate of the hollow glass may be lowered by using the glass fiber.

As described above, it is obvious that although the present invention has been described with reference to the drawings illustrated, the present invention is not limited by the embodiments and drawings disclosed herein, and various modifications may be made by those skilled in the art within the scope of the technical idea of the present invention. In addition, although the operational effects according to the configuration of the present invention have not been explicitly described and described while describing the embodiments of the present invention, it is natural that the effects predictable by the corresponding configuration should also be recognized.

1. A lightweight composite composition comprising:
50 to 80% by weight of a polyolefin-based resin;
10 to 30% by weight of an inorganic additive having a specific gravity of 0.1 to 0.6 g/cm³;
5 to 10% by weight of a reinforcing material having an aspect ratio of 200 to 1000; and
3 to 10% by weight of a compatibilizer for combining the polyolefin-based resin, inorganic additive, and reinforcing material.

2. The lightweight composite composition of claim 1, wherein the lightweight composite composition has a melt index of 14 to 20 g/10 min as measured by ASTM D1238 at 220° C.

3. The lightweight composite composition of claim 1, wherein the polyolefin-based resin includes at least one of polypropylene (PP), polyethylene (PE), or polybutylene (PB).

4. The lightweight composite composition of claim 1, wherein the inorganic additive includes at least one of a hollow glass, calcium carbonate, titanium oxide, or silica.

5. The lightweight composite composition of claim 1, wherein the reinforcing material includes at least one of a glass fiber or a carbon fiber.

6. The lightweight composite composition of claim 1, wherein the compatibilizer includes at least one of,
2,5-dimethyl-2,5-bis (t-butylperoxy) hexane,
1,3-bis(t-butylperoxyisopropyl) benzene,
methyl ethyl ketone peroxide,
2,5-dimethyl-2,5-di(benzoyloxy)hexane,
di-t-butylperoxide,
2,5-dimethyl-2,5-(t-butylperoxy)-3-hexane,
n-butyl-4,4-bis (t-butylperoxy) valerate,
a,a′-bis(t-butylperoxy) diisopropylbenzene, or
maleic anhydride-grafted polpropylene.

7. The lightweight composite composition of claim 1, wherein:
the polyolefin-based resin and the compatibilizer are supplied to a main feeder to form a first mixture;
the inorganic additive is supplied to a first side feeder provided downstream of the main feeder to mix the inorganic additive with the first mixture of the polyolefin-based resin and the compatibilizer;
the reinforcing material is supplied to a second side feeder provided downstream of the first side feeder to mix the reinforcing material with the second mixture to form a third mixture; and
the third mixture is extruded through an extrusion die.

8. The lightweight composite composition of claim 7, wherein the third mixture is extruded at a loading of less than 50%.

9. The lightweight composite composition of claim 7, wherein the polyolefin-based resin includes polypropylene that is included in an amount of 40 to 80% by weight of the lightweight composite.

10. The lightweight composite composition of claim 7, wherein the compatibilizer includes one or more of;
2,5-dimethyl-2,5-bis(t-butylperoxy)hexane,
1,3-bis(t-butylperoxyisopropyl)benzene, methyl ethyl ketone peroxide,
2,5-dimethyl-2,5-di(benzoyloxy)hexane,
di-t-butylperoxide,
2,5-dimethyl-2,5-(t-butylperoxy)-3-hexane,
n-butyl-4,4-bis(t-butylperoxy)valerate,
a,a′-bis(t-butylperoxy)diisopropylbenzene, or
maleic anhydride-grafted polypropylene.

11. The method of claim 7, wherein the compatibilizer includes maleic anhydride-grafted polypropylene in an amount of 3 to 10% by weight of the lightweight composite.

12. The lightweight composite composition of claim 7, wherein the inorganic additive includes hollow glass that has a specific gravity of 0.1 to 0.6 g/cm³.

13. The lightweight composite composition of claim 7, wherein the inorganic additive includes hollow glass that is included in an amount of 10 to 30% by weight of the lightweight composite.

14. The lightweight composite composition of claim 7, wherein the reinforcing material includes glass fiber having an aspect ratio of 200 to 1000.

15. The lightweight composite composition of claim 7, wherein the reinforcing material includes glass fiber that is included in an amount of 5 to 10% by weight of the lightweight composite.

16. The lightweight composite composition of claim 1, wherein the lightweight composite composition comprises:
61-67% by weight of the polyolefin-based resin;
10-20% by weight of the inorganic additive;
8-10% by weight of the reinforcing material; and
5-10% by weight of the compatibilizer.
